(19) United States
(12) Patent Application Publication
(10) Pub. No.: US 2002/0088659 A1
(43) Pub. Date: Jul. 11, 2002

(54) Powered scooter

(76) Inventor: Wai Yee Wong, Hong Kong (CN)

Correspondence Address: Raymond Yat Chan, 1050 Oakdale Lane, Arcadia, CA, 91006, US

(21) Appl. No.: 09/755,887

(22) Filed: Jan. 5, 2001

(51) Int. Cl. B62K 11/00; B62D 61/02

(52) U.S. Cl. 180/220

(57) ABSTRACT

A powered scooter includes a frame, a front wheel rotatably supported at a front portion of the frame, a rear wheel assembly including at least a rear wheel rotatably supported at a rear portion of the frame, a power generator for driving an output axle to rotate, a power source connecting to the power generator, and a friction rotor connected to the output axle which drives the friction rotor to rotate, wherein the friction rotor is supported to extend to bias against at least a driven portion of the rear wheel assembly so as to drive the rear wheel to rotate.

### BACKGROUND OF THE PRESENT INVENTION

1. Field of Invention

The present invention relates to a scooter, and more particularly to a powered scooter which is adapted to be powered by means of frictional force so as to eliminate the co-operation of a transmission. Furthermore, the powered scooter comprises a detachable power generator arranged in such a manner that the powered scooter is selectively impelled by means of electrical power or by foot manually.

2. Description of Related Arts

Nowadays, scooters are well known and have been considered as a form of transportation, recreation, and exercise. A conventional scooter comprises a step board for supporting a rider in a standing position, a steering frame having a front wheel operatively attached to a front portion of the step board, and a rear wheel rotatably attached to a rear portion of the step board. In which, one foot of the rider is supported on the step board while the conventional scooter is propelled by another foot of the rider. It is no doubt that the conventional scooter is lightweight, portable, and safe. However, the rider may still have a chance to carry the scooter especially when the rider is tired while operating for a long period of time. So, an alternative is sought for. An improved scooter is equipped with an electric motor or an engine so that such scooter is propelled by means of mechanical power.

However, the motorized scooter still has many drawbacks. When the scooter is equipped with a motor, the structure of the scooter must be altered in order to fit the motor. Such complex structure of the scooter will highly increase the manufacturing cost and the maintenance cost of the scooter. Also, the motor will increase the overall weight of the scooter so as to loss most of the ordinary features such as lightweight and portable of the scooter. Since the motorized scooter is powered by the motor all the time, the scooter has loss a meaning of exercise.

In addition, the major drawback of the motorized scooter is that no matter what the rear wheel of the scooter is driven by means of driving belt or directly by a rotor shaft extended from the motor, when the scooter uses up its power, the rear wheel of the scooter is locked up by the motor. So, the rider may merely carry the heavy scooter by hand instead of rolling the scooter on the street.

### SUMMARY OF THE PRESENT INVENTION

A main object of the present invention is to provide a powered scooter which is propelled by a frictional force generated by a power generator.

Another object of the present invention is to provide a powered scooter wherein the rotation speed of an output axle of the power generator is automatically reduced due to the smaller diameter of the friction rotor with respect to the much larger diameter of the rear wheel of the scooter.

Another object of the present invention is to provide a powered scooter which does not require to alter the original simple structure so as to reduce the manufacturing cost of the scooter incorporating with the motor.

Another object of the present invention is to provide a powered scooter wherein no expensive and complicate transmission mechanism is required to transmit the power form an electric motor or an engine to drive the rear wheel to rotate.

Another object of the present invention is to provide a powered scooter, which is adapted to selectively adjust a transmitting power from the power generator, i.e. the transmission of the scooter, by means of the frictional force.

Another object of the present invention is to provide a powered scooter which comprises a motor arranged in a manner that the powered scooter is adapted for selectively propelling by a frictional force from a power generator or by foot manually. The user may switch the scooter to powered operate or to manual operate anytime and anywhere easily. In other words, even though the power generator is run out of power, the powered scooter can be operated by manually.

Accordingly, in order to accomplish the above objects, the present invention provides a powered scooter, which comprises a frame; a front wheel rotatably supported at a front portion of the frame; a rear wheel assembly comprising at least a rear wheel rotatably supported at a rear portion of the frame; a power generator for driving an output axle to rotate; a power source connecting to the power generator; and a friction rotor connected to the output axle which drives the friction rotor to rotate, wherein the friction rotor is supported to extend to bias against at least a driven portion of the rear wheel assembly so as to drive the rear wheel to rotate.

### BRIEF DESCRIPTION OF THE DRAWINGS

FIG. 1 is a rear perspective view of a powered scooter according to a preferred embodiment of the present invention.

FIG. 2 is a partially perspective view of the powered scooter according to the above preferred embodiment of the present invention.

FIG. 3 is a rear view of the powered scooter according to the above preferred embodiment of the present invention.

FIG. 4 is a partially exploded perspective view of the powered scooter according to the above preferred embodiment of the present invention.

FIG. 5 illustrates a power generator of the powered scooter in a driving position according to the above preferred embodiment of the present invention.

FIG. 6 illustrates the power generator of the powered scooter in an idle position according to the above preferred embodiment of the present invention.

FIG. 7 illustrates an alternative mode of a rear wheel assembly of the powered scooter according to the above preferred embodiment of the present invention.

### DETAILED DESCRIPTION OF THE PREFERRED EMBODIMENT

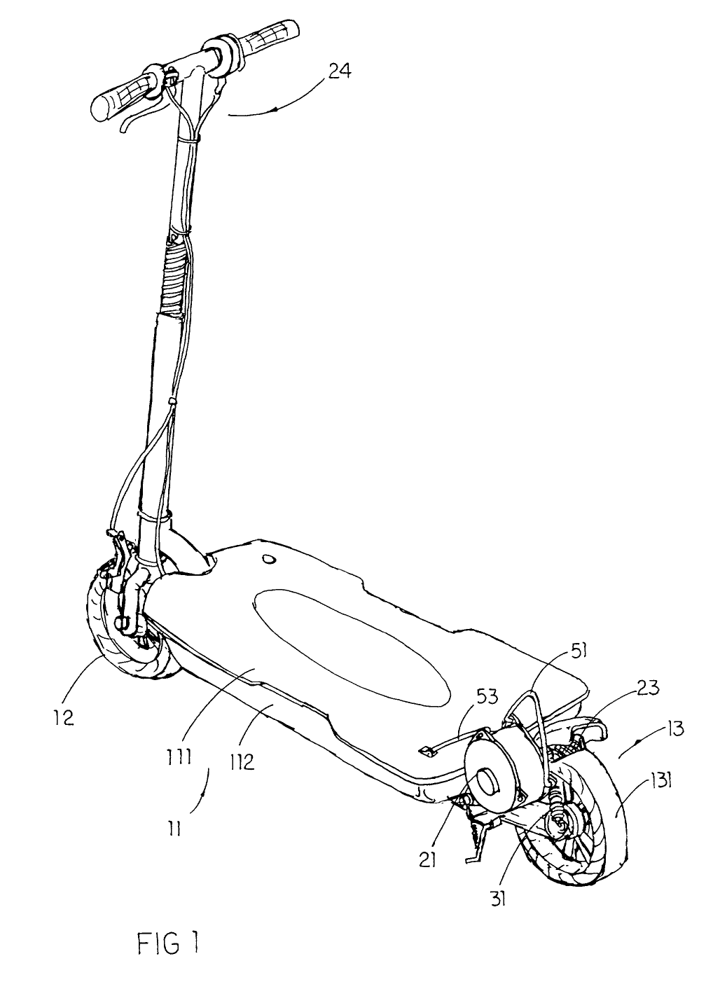

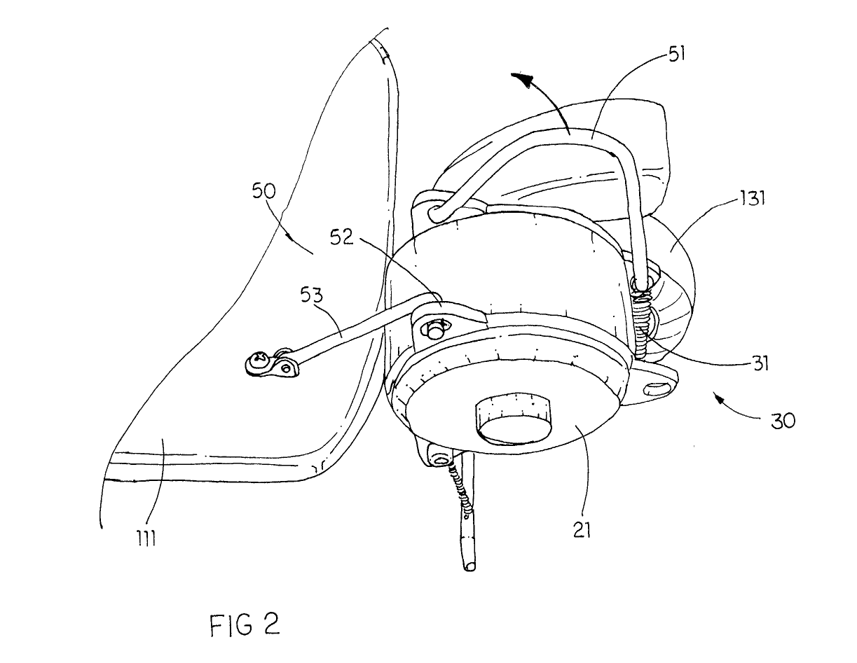

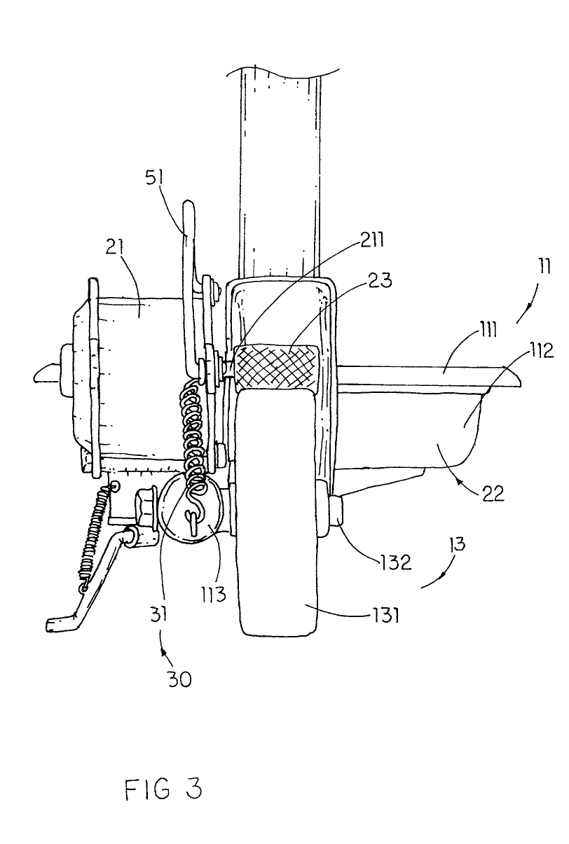

Referring to FIGS. 1 through 3 of the drawings, a powered scooter according to a preferred embodiment of the present invention is illustrated, wherein the powered scooter, such as a standard scooter, comprises a frame 11, a front wheel 12 rotatably supported at a front portion of the frame 11, and a rear wheel assembly 13 comprising at least a rear wheel 131 rotatably supported at rear portion of the frame 11.

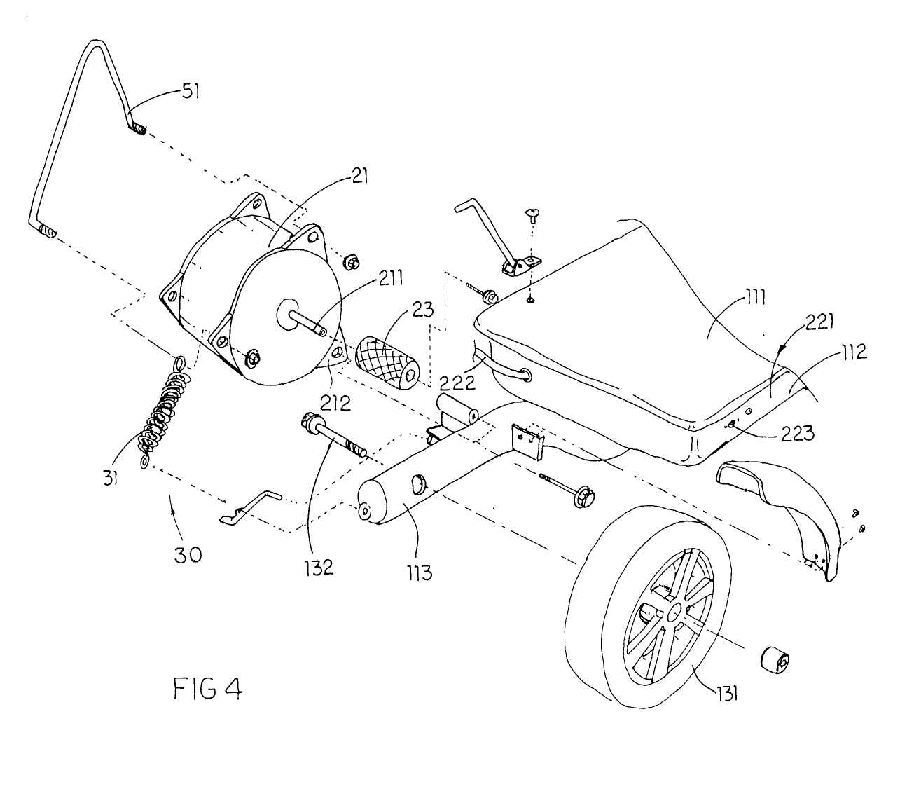

As shown in FIG. 4, the powered scooter further comprises a powered assembly comprising a power generator 21 for driving an output axle 211 to rotate, a power source 22 connecting to the power generator 21, a friction rotor 23 connected to the output axle 211 which drives the friction rotor 23 to rotate, wherein the friction rotor 23 is supported to extend to bias against at least a driven portion of the rear wheel assembly 13 so as to drive the rear wheel 131 to rotate, and means for controllably coupling 24 rotational energy from the power generator 21 to the rear wheel assembly 13.

According to the preferred embodiment, the frame 11 comprises a step board 111 for supporting a rider thereon, a housing 112 provided underneath the step board 111 for receiving and protecting the power source 22 therein, and a supporting bar 113 supportively mounted underneath the housing 112 wherein the rear wheel 131 is rotatably supported at a rear portion of the supporting bar 113 by means of a driving axle 132.

The power generator 21 is detachably mounted at a rear portion of the supporting bar 113 by means of, for example, a bolt and nut connection or other similar connection means, wherein the power generator 21 is aligned in parallel with the rear wheel 131 so as to extend the output axle 211 of the power generator 21 towards the rear wheel 131. The power generator 21 can be an electric motor as embodied in the preferred embodiment of the present invention or a fuel engine.

The friction rotor 23 is preferably made of durable rough material that can provide friction between the friction rotor 23 and the driving portion of the rear wheel assembly 13 when the friction rotor 23 is arranged to press against the driving portion of the rear wheel assembly 13, so as to drive the rear wheel 131 to rotate. As shown in FIG. 5, the friction rotor 23 is suspendedly supported by the output axle 211 and arranged to frictionally bias against a periphery surface of the rear wheel 131, i.e. the driven portion according to the preferred embodiment as shown in FIG. 5, in such a manner that the power generator 21 is arranged to drive the friction rotor 23 to rotate through the output axle 211 so as to frictionally drive the rear wheel 131 to rotate.

It is worth to mention that the friction rotor 23 is preferred to bias against an inner portion of the periphery surface of the rear wheel 131 under a predetermined pressure so as to enhance a contacting area therebetween and minimize the loss of the frictional force transmitting from the friction rotor 23 to the rear wheel 131. In other words, the rear wheel 131 is rotatably driven downwardly at the inner portion of the rear wheel 131, which is better than the rear wheel 131 being rotatably driven upwardly at an outer portion of the rear wheel 131 to against the gravity.

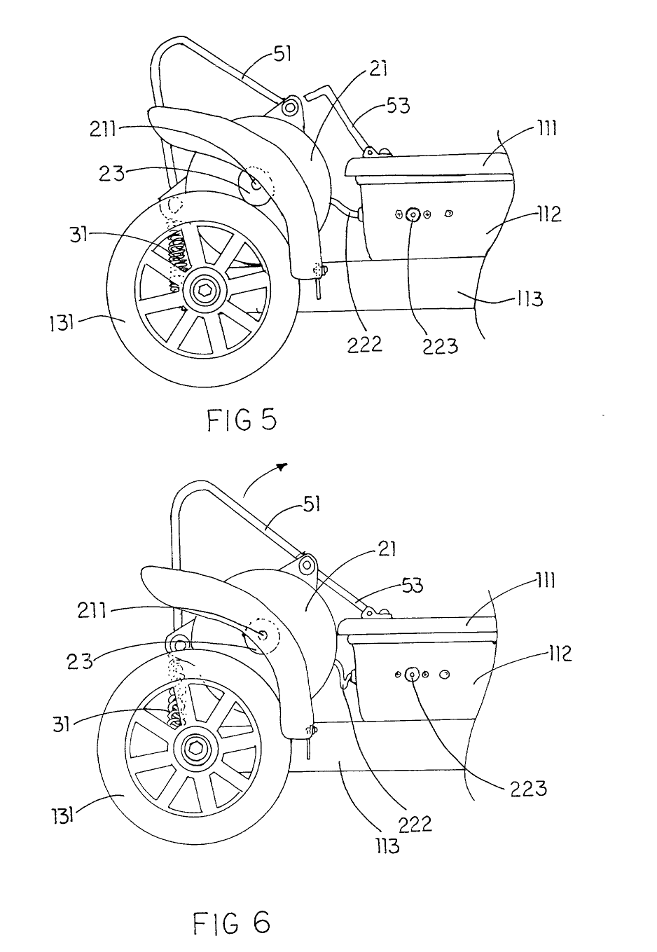

The power generator 21 is pivotally mounted on the supporting bar 113 at an inner portion thereof wherein the power generator 21 is adapted for pivotally moving on the frame 11 from a normal driving position as shown in FIG. 5, to an idle position as shown in FIG. 6. In which, in the driving position, the friction rotor 23 is frictionally biased against the periphery surface (driven portion) of the rear wheel 131 of the rear wheel assembly 13 so as to drive the rear wheel 131 to rotate. In the idle position, the friction rotor 23 is moved away from the periphery surface of the rear wheel 131 of the rear wheel assembly 13 such that the rear wheel 131 is in a free rotating manner. One simple way to move the friction rotor 23 away from the rear wheel 131 is to detach the friction rotor 23 from the output axle 211.

In order to ensure a good frictional contact between the friction rotor 23 and the rear wheel 131, the power generator 21 is preferred to mount to the supporting bar 113 pivotally, wherein a supporting member 212, which is protruded at a front bottom end of the power generator 21, is pivotally connected to the supporting bar 113, as shown in FIG. 4. Moreover, the powered scooter further comprises a reinforcing engagement device 30 for applying an urging pressure against the power generator 21 so as to normally retain the power generator 21 in the driving position. The reinforcing engagement device 30, according to the preferred embodiment, comprises a resilient element 31 which is a compression spring detachably attached between the power generator 21 and the supporting bar 113 of the frame 11.

The resilient element 31 has two ends connected to a rear end of the supporting bar 113 and an outer portion of the power generator 21 respectively. Accordingly, the resilient element 31 generally pulls the power generator 21 downwards with respect to the pivot connection at the supporting member 212 thereof, so as to normally pull and retain the power generator 21 in a lower position and to urge and retain the friction rotor 23 frictionally biased against periphery surface of the rear wheel 131 to drive the rear wheel 131 to rotate. Thus, the frictional power transmission between the friction rotor 23 and the rear wheel 131 can be ensured.

It is worth to mention that the inner portion of the power generator 21 is pivotally mounted on the supporting bar 113 of the frame 11 and the outer portion of the power generator 21 is urged by the resilient element 31. By the pivotal movement, a distance between the outer portion of the power generator 21 and the inner portion thereof will increase a pivotal pulling force of the resilient element 31 such that the resilient element 31 can be pivotally pull down the power generator 21 in the lower position so as to enhance the friction rotor 23 engaged with the rear wheel 131.

Moreover, by varying the strength of the resilient element 31, the urging pressure of the resilient element 31 can be increased so as to increase the pivotal pulling force of the resilient element 31 to pivotally pull the power generator 21 downward. Alternatively, by varying a coupling position of the resilient element 31 with the outer portion of the power generator 21 can also adjust the pivotal pulling force of the resilient element 31. In other words, the larger distance from coupling position the resilient element 31 urged, the larger pivotal pulling force the resilient element 31 achieved.

The power source 22 comprises at least a rechargeable battery 221 received and protected in the housing 112 of the frame 11 and an electrical wire 222 extended from the rechargeable battery 221 to the power generator 21 through the housing 112. A transmitting power input 223 is adapted to electrically extend from the rechargeable battery 221 such that the rechargeable battery 221 is adapted for selectively recharging by an AC current charger or a DC current car charger through the transmitting power input 223.

The powered scooter further comprises a handle bar 51 and a locking device 50 for locking the power generator 21 in the idle position that the rear wheel 131 is in a free rotating manner. The handle bar 51 have two ends attached to the power generator 21 wherein the power generator 21 is arranged to pivotally rotate by pulling the handle bar upwardly in such a manner that the friction rotor 23 is driven to move away from the periphery surface of the rear wheel 131 so as to disengage the friction rotor 23 with the rear wheel 131.

The locking device 50 comprises a locking hook 53 pivotally extended from the frame 11 and a holding ring 52 extended from the power generator 21 in such a manner that the locking hook 453 is adapted for detachably hooking on the holding ring 52 when the power generator 21 is pull upwardly in the idle position.

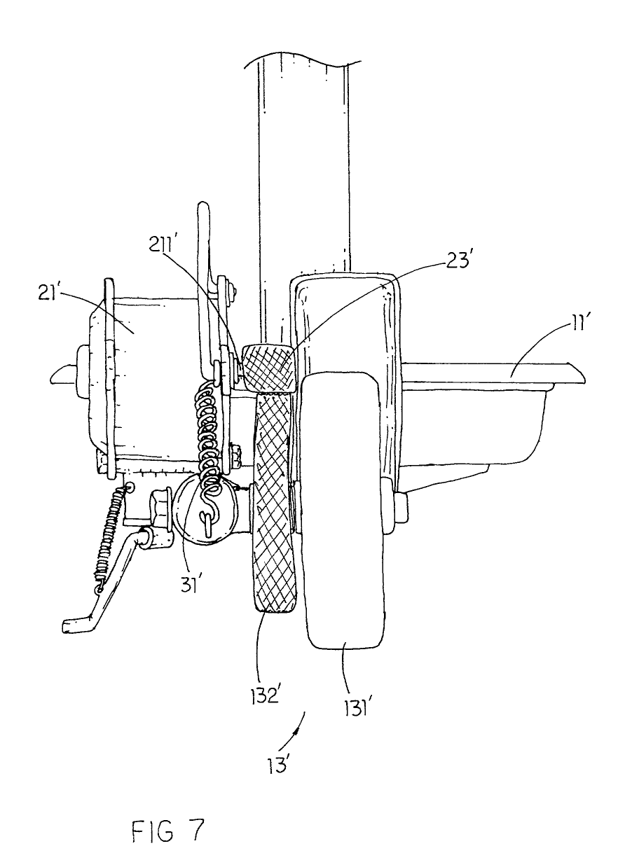

FIG. 7 illustrates an alternative mode of the rear wheel assembly 13′ of the powered scooter according to the preferred embodiment of the present invention, wherein the rear wheel assembly 13′ further comprises a driven wheel 133′ having a striking periphery surface coaxially affixed to the rear wheel 131′ wherein the friction rotor 23′ is extended to bias against the striking periphery surface of the driven wheel 133′ so as to drive the rear wheel 131′ to rotate.

The striking periphery surface of the driven wheel 133′ is preferably made of durable rough material so as to increase the frictional force between the friction rotor 23′ and the driven wheel 133′ to enhance a rotating speed of the rear wheel 131′. In addition, the friction rotor 23′ can be protected from being damaged while operating since sands and stones may stick on the rear wheel 131′ and hit on the friction rotor 23′ when the rear wheel 131′ is rotating on the ground.

While the foregoing description describes the preferred embodiment and its alternative, the power generator is adapted for being installed into any existing scooter having a rear wheel mounted thereon. In other words, the power generator can be detached from the frame of the scooter such that the power generator is optional to install into the scooter when the need of the power generator. Since the powered scooter of the present invention is propelled by the frictional force, no transmission such as driving belt is required in order to operate the scooter, which can simplified the structure of the scooter to minimize the manufacturing cost of the present invention. Thus, the speed of the scooter can be selectively controlled by the frictional force exerted on the driven portion of the rear wheel assembly.

Accordingly, according to the above described embodiment, the powered scooter of the present invention can substantially achieve the following improved advantages.

(1) The powered scooter which is propelled by a frictional force generated by a power generator, wherein the rotation speed of an output axle of the power generator is automatically reduced due to the smaller diameter of the friction rotor with respect to the much larger diameter of the rear wheel of the scooter.

(2) The powered scooter does not require to alter the original simple structure so as to reduce the manufacturing cost of the scooter incorporating with the motor.

(3) In the powered scooter, no expensive and complicate transmission mechanism is required to transmit the power form an electric motor or an engine to drive the rear wheel to rotate.

(4) The powered scooter is adapted to selectively adjust a transmitting power from the power generator, i.e. the transmission of the scooter, by means of the frictional force.

(5) The powered scooter comprises a motor arranged in a manner that the powered scooter is adapted for selectively propelling by a frictional force from a power generator or by foot manually. The user may switch the scooter to powered operate or to manual operate anytime and anywhere easily. In other words, even though the power generator is run out of power, the powered scooter can be operated by manually.

What is claimed is:

1. A powered scooter, comprising:
a frame;
a front wheel rotably supported at a front portion of said frame;
a rear wheel assembly comprising at least a rear wheel rotably supported at a rear portion of said frame;
a power generator for driving an output axle to rotate;
a power source connecting to said power generator; and
a friction rotor connected to said output axle which drives said friction rotor to rotate, wherein said friction rotor is supported to extend to bias against at least a driven portion of said rear wheel assembly so as to drive said rear wheel to rotate.

2. A powered scooter, as recited in claim 1, wherein said power generator is pivotally mounted at a rear end portion of said frame and a reinforcing engagement device is connected between said power generator and said frame so as to apply an urging pressure against said power generator so as to urge and retain said friction rotor to bias against said driven portion of said rear wheel assembly.

3. A powered scooter, as recited in claim 2, wherein said reinforcing engagement device comprises a resilient element having two ends detachably connect with said rear end portion of said frame and said power generator respectively, so as normally urge and retain said power generator in a lower position that said friction rotor is frictionally biased against said driven portion of said rear wheel assembly to drive said rear wheel to rotate, so as to ensure a frictional power transmission between said friction rotor and said driven portion of said rear wheel assembly.

4. A powered scooter, as recited in claim 1, wherein said friction rotor is frictionally biased against a periphery surface of said rear wheel of said rear wheel assembly so as to drive said rear wheel to rotate.

5. A powered scooter, as recited in claim 2, wherein said friction rotor is frictionally biased against a periphery surface of said rear wheel of said rear wheel assembly so as to drive said rear wheel to rotate.

6. A powered scooter, as recited in claim 3, wherein said friction rotor is frictionally biased against a periphery surface of said rear wheel of said rear wheel assembly so as to drive said rear wheel to rotate.

7. A powered scooter, as recited in claim 4, wherein said friction rotor is frictionally biased against an inner portion of said periphery surface of said rear wheel so as to enhance a contacting area therebetween and minimize a loss of a frictional force transmitting from said friction rotor to said rear wheel.

8. A powered scooter, as recited in claim 5, wherein said friction rotor is frictionally biased against an inner portion of said periphery surface of said rear wheel so as to enhance a contacting area therebetween and minimize a loss of a frictional force transmitting from said friction rotor to said rear wheel.

9. A powered scooter, as recited in claim 6, wherein said friction rotor is frictionally biased against an inner portion of said periphery surface of said rear wheel so as to enhance a contacting area therebetween and minimize a loss of a frictional force transmitting from said friction rotor to said rear wheel.

10. A powered scooter, as recited in claim 2, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

11. A powered scooter, as recited in claim 3, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

12. A powered scooter, as recited in claim 5, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

13. A powered scooter, as recited in claim 6, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

14. A powered scooter, as recited in claim 8, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

15. A powered scooter, as recited in claim 9, wherein said frame comprises a step board supported by a supporting bar extended underneath said step board, wherein said power generator at an inner portion thereof is pivotally mounted on a rear end portion of said supporting bar to pivotally move from a normal driving position to an idle position, wherein in said driving position, said friction rotor is frictionally biased against said driven portion of said rear wheel assembly so as to drive said rear wheel to rotate, and in said idle position, said friction rotor is moved away from said driven portion of said rear wheel assembly such that said rear wheel is in a free rotating manner.

16. A powered scooter, as recited in claim 10, further comprising a locking device for locking up said power generator in said idle position to maintain said rear wheel in a free rotating manner.

17. A powered scooter, as recited in claim 11, further comprising a locking device for locking up said power generator in said idle position to maintain said rear wheel in a free rotating manner.

18. A powered scooter, as recited in claim 12, further comprising a locking device for locking up said power generator in said idle position to maintain said rear wheel in a free rotating manner.

19. A powered scooter, as recited in claim 13, further comprising a locking device for locking up said power generator in said idle position to maintain said rear wheel in a free rotating manner.

20. A powered scooter, as recited in claim 14, further comprising a locking device for locking up said power generator in said idle position to maintain said rear wheel in a free rotating manner.

21. A powered scooter, as recited in claim 15, further comprising a locking device for locking up said power generator in said idle position to maintain said rear wheel in a free rotating manner.
